(19) United States
(12) Patent Application Publication
(10) Pub. No.: US 2006/0004621 A1
(43) Pub. Date: Jan. 5, 2006

(54) Real-time selection of survey candidates

(76) Inventors: Kamal M. Malek, Weston, MA (US); Kevin D. Karty, Los Alamos, NM (US); David B. Teller, Boston, MA (US); Sevan Ficici, Cambridge, MA (US)

Correspondence Address: EDWARDS & ANGELL, LLP, P.O. BOX 55874, BOSTON, MA, 02205, US

(21) Appl. No.: 10/881,154

(22) Filed: Jun. 30, 2004

(51) Int. Cl. G06Q 90/00

(52) U.S. Cl. 705/10

(57) ABSTRACT

A method of evaluating a candidate for participation in a survey by obtaining, over an electronic network, information describing the candidate, categorizing the candidate, determining if adding the candidate would increase the population in a group beyond a specified threshold, and conditionally excluding the candidate. Otherwise, allowing the candidate to participate in the survey and obtaining preferential information describing the candidate's affinity for one or more decision objects.

### FIELD OF THE INVENTION

The present invention relates generally to surveys and more specifically to evaluating and selecting candidates for participation in an online survey.

### BACKGROUND OF THE INVENTION

Customer surveys are an efficient way to collect consumer preference data before bringing a product to market. A survey typically consists of a survey presenter, or surveyor, providing a survey respondent, or participant, with a series of questions, the answers to which provide insight into the participant's preferences for particular choices or consumer goods. A typical survey may include a series of oral questions, a written multiple-choice questionnaire, or interactive online exercises. The survey format often relieves the surveyor of the burden of actually manufacturing physical product models to test the market, instead allowing him to convey verbal choices or graphical illustrations of choices to gauge potential customer affinity. Consequently, development costs are often significantly reduced, and a given product may be brought to a market in which it should theoretically succeed.

Computers, specifically those connected to electronic networks such as the Internet, are ideal as survey communication mediums because they allow participants to be remotely located and asynchronously queried. When a survey is presented over an electronic network, a participant is able to interact with the survey over a large geographical distance, at a time that is convenient to him. Since computers used by participants and surveyors need not be physically close nor administered by a surveyor during the survey, this greatly expands the pool of possible participants and simplifies survey administration overhead.

One limitation to traditional computerized surveys, however, is that options presented to participants generally need to be defined ahead of time. A computer survey program typically presents all questions in a predetermined order, regardless of responses given by the participant. Thus, the order survey questions and options are presented in is typically fixed before the survey begins.

Even surveys that vary option presentation order based on participant responses suffer an aspect of this limitation. Though the order of a participant's decision options, or decision objects, may be variable, the decision objects themselves are generally fixed. Typically, these survey programs rely on logic, between object presentations, similar to: “if the participant gave response A, display decision object C instead of B.” Typical survey programs cannot process rules equivalent to “if the participant gave response A, display a decision object previously unconceived of because they lack the means to create decision objects not entered by the surveyor. To address this concern, there exist online evolutionary surveys that modify or evolve populations of decision objects in real-time based upon participant preference. For those surveys, participants may join, participate, and leave asynchronously. In such surveys, calculations, inferences, and decisions regarding group and subgroup preferences are performed dynamically, that is, in real-time, during the survey fielding period. This variable participant population and variable decision object survey model leads to a convergence of preferences about the presented decision objects that can be greatly affected depending upon the characteristics of the past and active survey participants at any given point in time. In essence, if at any time an excessive number of homogenous participants interact with an evolutionary survey, they may substantially alter the natural evolution of the decision objects under consideration.

### SUMMARY OF THE INVENTION

Thus there is a need for a method for evaluating and selecting candidates to participate in an online survey that exerts real-time control over participant group representation in order to ensure that decision objects are not evolved by statistically undesirable candidates.

In satisfaction of this need, the present invention provides systems and methods for ensuring proper participant representation, by only allowing candidates to participate in the survey that will neither cause over-representation nor under-representation of certain participant groups. In accordance with the invention, avoidance of under or over representation may be accomplished either by allowing participation by the candidate but excluding the collected data from the survey's real-time computations, or simply by excluding the candidate from participating.

In accordance with one aspect of the invention, a method of evaluating a candidate for participation in a survey is provided. Through execution of this method, information describing the candidate is initially obtained over an electronic network. Based on the obtained information, the candidate is categorized as a potential member of one or more predetermined groups. For each predetermined group, if adding the candidate to that particular group would increase the population in that group beyond a specified representation threshold, then the candidate is excluded from participating in the survey. Otherwise, the candidate is added as a member of each predetermined group and allowed to participate in the survey.

In accordance with another aspect of the invention, a method of evaluating a candidate for participation in a survey is provided. Through execution of this method, information describing the candidate is initially obtained over an electronic network. Based on the obtained information, the candidate is categorized as a potential member of one or more predetermined groups. For each predetermined group, if adding the candidate to that particular group would decrease the population of any other group below a specified representation threshold, then the candidate is excluded from participating in the survey. Otherwise, the candidate is added as a member of each predetermined group and allowed to participate in the survey.

In accordance with yet another aspect of the invention, a system for evaluating a candidate for participation in a survey is provided. The system includes a computer, connected to an electronic network, configured to obtain, over the electronic network, information describing the candidate. Based on the obtained information, the candidate is categorized as a potential member of one or more predetermined groups. For each predetermined group, if adding the candidate to that particular group would decrease the population of any group below a specified representation threshold, then the candidate is excluded from participating in the survey. Otherwise, the candidate is added as a member of each predetermined group and allowed to participate in the survey.

In accordance with another aspect of the invention, a method is provided for assessing the preferences of an objectively predefined consumer group from among decision objects. In this aspect, decision objects include various forms of a product, or different product options. In accordance with this method, while conducting a survey over an electronic network, a potential new candidate is permitted to request participation in the survey. Next, data is obtained, through the network, relevant to determining whether the candidate may be classified as a member of an objectively predefined consumer group. The candidate is then excluded from participating in the survey if either adding the candidate would result in over-representation of a subtype of consumer in the group, or the candidate is objectively not includable on the group. Otherwise, the candidate is allowed to participate in the survey and to provide preference information indicative of his or her affinity for one or more decision objects. When the survey uses the preference information to evolve one or a preferred group of product forms, this practice permits the product developer to discover product forms comprising a combination of attributes preferred by an objectively defined group.

### BRIEF DESCRIPTION OF THE DRAWINGS

These and other aspects of the present invention, as well as the invention itself, will be more fully understood from the detailed description below and the appended drawings, which are meant to illustrate and not limit the invention, and in which:

FIG. 1 depicts an electronic network in accordance with one embodiment of the present invention.

FIG. 2 depicts an electronic network connecting potential candidates to a central host.

FIG. 3A is a flowchart depicting a method of either allowing or excluding candidates from a survey.

FIG. 3B depicts one possible method of excluding a candidate in accordance with the embodiment depicted in FIG. 3A.

FIG. 3C depicts an another method of excluding a candidate in accordance with the embodiment depicted in FIG. 3A.

FIG. 4 is a flowchart illustrating a method for assessing the preferences of a group for one or more decision objects.

### DETAILED DESCRIPTION

The claimed invention provides methods and systems for regulating the number and characteristics of candidates who are allowed to participate in an online survey. [0014 Traditional market surveys involve polling participants, tabulating their responses, and possibly using those responses to develop a statistical model that is then used to gain insight into, and make inferences about, the preferences or opinions of the participants. As discussed previously, modem approaches to survey administration utilize computers and electronic networks to poll larger and more diverse populations than was traditionally possible. Although it is now easier than ever to survey a large population, most existing techniques still generally employ traditional methods of static questions for collecting participant preferences. While this is still useful, questions and options must be planned ahead of time so that the statistical model used for analysis will represent an accurate picture of the responses received. Under certain conditions, questions and choices may be randomized dynamically (on-the-fly.)

Ideally, survey options could be created on-the-fly, based on the answers provided by participants. And indeed, this is currently done in some cases, but it typically involves creating or modifying the questions or options presented to a respondent based on his or her responses to earlier questions. This is the case in survey designs that implement skip rules or answer piping; it is also the case in certain adaptive conjoint schemes.

In contrast to those traditional methods, a new type of survey makes it possible to modify the choices presented to a participant, not only as a result of earlier answers from the participant, but also based on preference information provided by other participants to similar or related questions within the same survey. These other participants may have provided the preference information much earlier during the survey fielding period, or they could be providing it almost contemporaneously with the first participant.

One exemplary online survey methodology modifies decision objects during the course of the survey using genetic or evolutionary algorithms to develop new, more preferable decision objects. This approach is described in co-pending U.S. application Ser. No. 10/053,353 filed Nov. 9, 2001 and entitled “Method and Apparatus for Dynamic, Real-Time Market Segmentation,” which is incorporated herein by reference.

Generally, an evolutionary approach begins by asking participants to rate or compare decision objects presented on a screen. Through mutation and breeding, “progeny” of some of the decision objects are then created and shown to one or more of the participants. Preferably, these new decision objects inherit desirable characteristics from their parent decision objects.

The genetic algorithm-driven survey is similar to a standard market research study wherein participants are asked to evaluate a plurality of choices and provide information indicating their preferences. Unlike a typical market research study, however, participants see a panel of decision objects that are sampled from a population of such objects, a population that is evolving in real-time based upon the preferences expressed by a plurality of the participants. Because the total population of the decision objects is evolving constantly, and participants may join and exit the survey at any time, it is important that the participants allowed to participate in the survey at any given time have demographic and other characteristics desired by the surveyor. Towards that end, embodiments of the present invention constantly evaluate and select candidates for participation in the survey in order to ensure that the decision object population is only evolved by participants satisfying certain conditions.

For example, assume that no control is exerted over who participates in a survey. Also assume that there are fifty participants from Texas, that all share similar preferences, for every Alaskan participant. As decision objects are evolved based on participant preference data, the decision objects naturally converge toward what the Texans prefer, since they have fifty times the representation of the Alaskans. Thus decision objects preferred by Alaskans will quickly be selected or evolved out of existence. If consumer preferences worldwide are closer to the Alaskan's preference than to the Texans', then the surveyor will be much more successful if he limits the number of Texan participants. Therefore there is a need to regulate the number and type of candidates who participate in the survey.

Note that this need does not exist in traditional survey approaches, where the analysis of obtained data is performed after the fielding period. In that model, the surveyor is able to easily correct imbalances in respondent representation. Typically, this is done through a number of corrective measures, including: leaving certain responses out of the analysis, weighting the responses of the under-represented group more heavily, and/or re-sampling (with replacement) the responses of the under-represented group in order to generate a larger sample (an approach similar to bootstrapping in statistical analysis.)

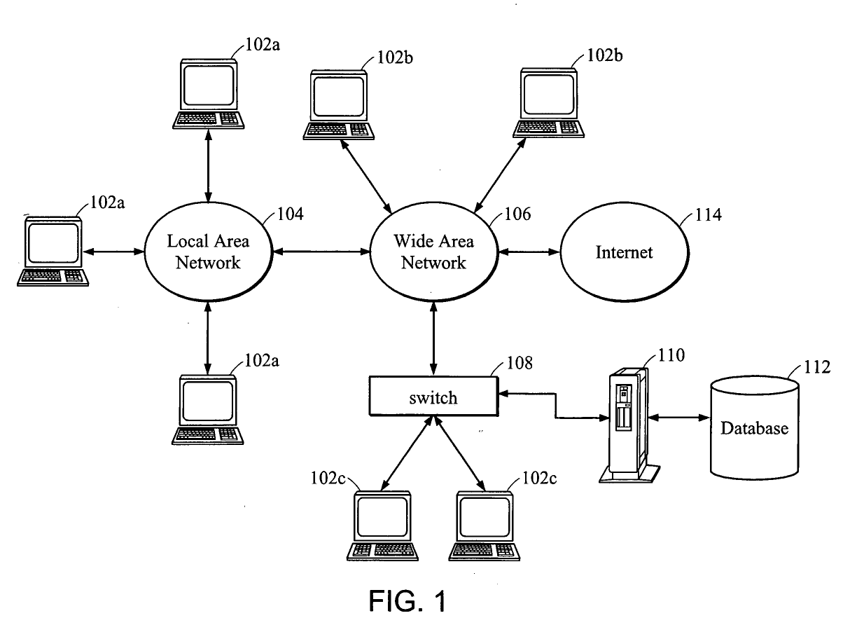

To better understand the claimed invention, a general overview of the architecture of a system in accordance with an embodiment will be illustrative. FIG. 1 depicts an electronic network in accordance with one embodiment of the present invention. A terminal 102a, which could be a desktop PC, a laptop computer, a kiosk, or other means for interfacing with a survey candidate or participant, is preferably connected to a Local Area Network 104 (LAN). LANs 104 comprise any number of terminals, servers, network storage devices, databases, printers, hubs, or other network appliances. The LAN 104 may in turn be connected to a Wide Area Network 106 (WAN). WANs 106 generally cover a larger geographic area than a LAN 104 and comprise one or more LANs 104, as well as individual terminals 102b, and may be connected to one or more switches 108, the switches 108 being connected to still more terminals 102c. Additionally, the switch 108 may also be connected to a survey and real-time computation host 110, which is preferably connected to a database 112 for storing preference information. The WAN, in this embodiment, is connected to the Internet 114 so that participants that are not a part of the WAN 106 or LAN 104 may access the survey and real-time computation host 110. FIG. 1 represents only one embodiment of the present invention and other embodiments may comprise the survey host 110 being connected to the LAN 104 or accessed through the Internet 114 or other electronic communication means.

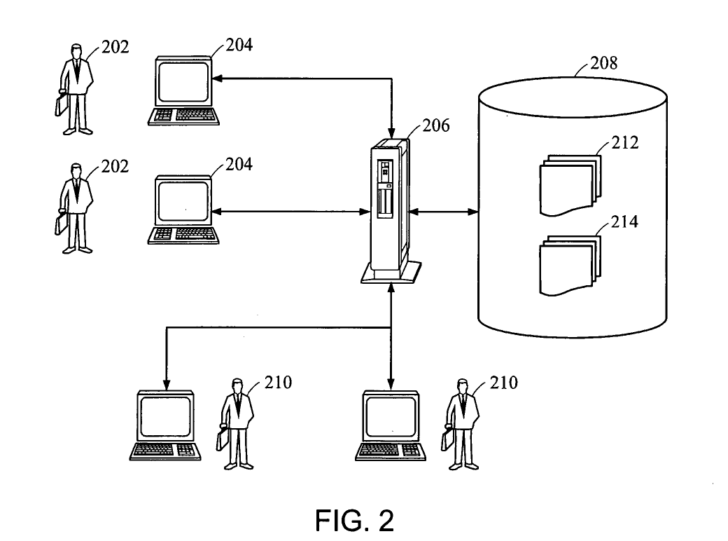

FIG. 2 depicts a typical electronic network connecting potential candidates to a central server, or host. In one embodiment, candidates 202 use terminals 204 to access a survey and real-time computation host 206. Once they are approved (as described below), the candidates 202 become participants 210 and continue their interaction with the host 206. The survey host 206 in turn accesses a database 208 to store information about the candidates 202. In some embodiments, the database 208 also stores preference information expressed by survey participants 210, or survey settings such as survey questions 212 or decision object attributes 214. Though the host 206 and database 208 are depicted as separate modules, one skilled in the art will recognize that they may be combined into one physical device or be located on separate LANs or WANs (104 and 106 from FIG. 1, respectively). As the participants 210 interact with the survey residing on the host 206, decision objects are evolved and presented to other participants 210. To maintain proper group representation among participants 210, the claimed invention provides methods of selecting which candidates 202 will be allowed into the survey to as participants 210.

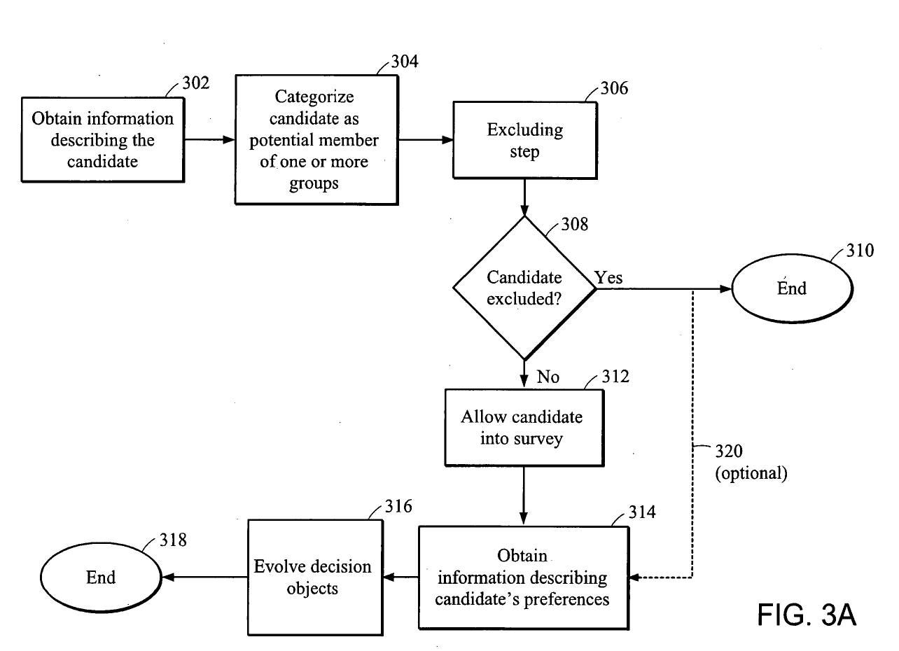

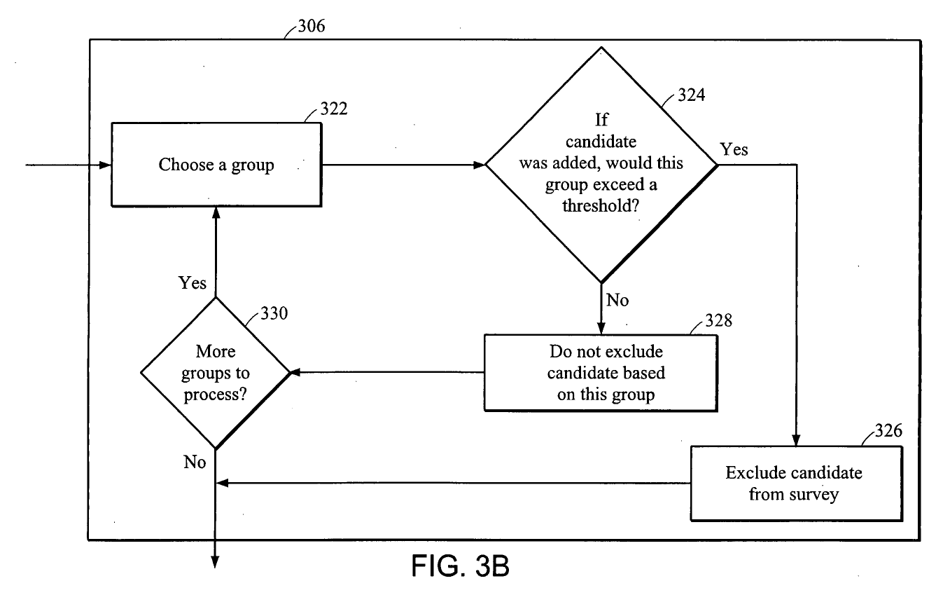

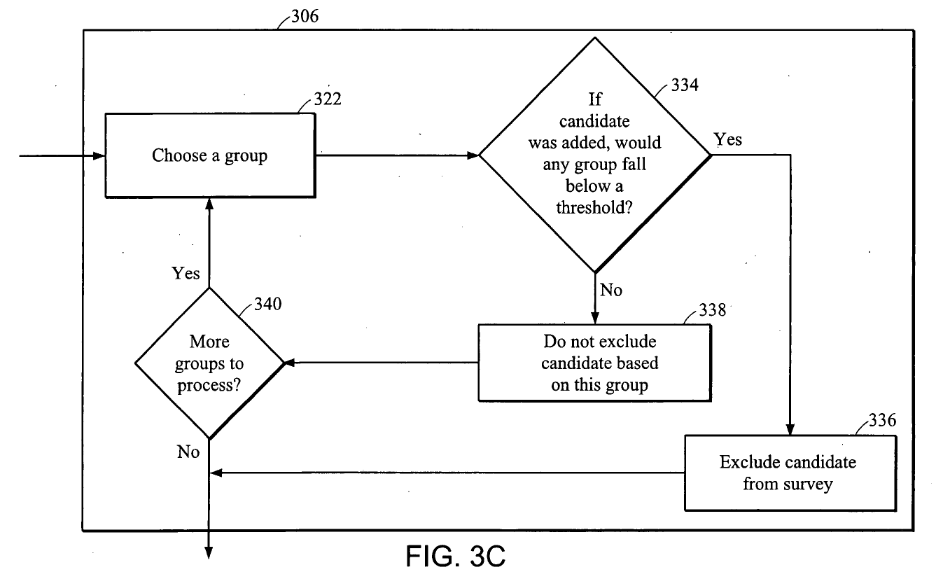

FIG. 3A is a flowchart depicting an aspect of the claimed invention wherein input from a candidate 202 is either allowed into, or excluded from, a survey. The process begins by obtaining information describing the candidate (step 302). Information may include any aspect of the life of the candidate considered relevant by the product developer, and includes, without limitation, the candidate's:
age;
race or ethnicity;
marital status;
income range;
gender;
occupation;
socio-economic classification;
level of education;
other demographic information;
consumption patterns;
purchase behavior (e.g., quantity purchased per store visit, or type of store where purchases typically made);
current use or ownership of particular products;
predisposition to purchase a particular product;
attitudinal information;
information used to classify the respondent into psychographic groups;
physical characteristics;
health;
geographic location; and
whether or not the candidate has previously participated in a survey.
   This permits collection of data relevant to the product preferences of diverse objectively defined groups: for example, teenage boys over six feet tall; married women in the Midwest over fifty with household incomes exceeding $75,000; or Hispanic men with post-graduate degrees seeking to purchase a new automobile.

The information is obtained over an electronic network (described above). Based on the information obtained, the candidate 202 is categorized as being a potential member of one or more groups (step 304). However, because surveyors generally desire only a certain amount of representation of a given participant-type (e.g., demographic) during a survey, care must be taken that before adding the candidate 202 to the pool of participants 210, the survey participant population size and proportions are controlled. Therefore, an excluding step (step 306) is performed to determine whether or not the candidate should be allowed to participate in the survey.

After the candidate has been categorized, it is then determined if the candidate 202 has been excluded (step 308) by the excluding step (step 306). If he has, his session ends (step 310) and he may be allowed to exit the survey or to go on to another survey. Alternatively, to the same effect, he may be permitted to participate, but his input is excluded. If he has not been excluded, he is allowed to participate in the survey (step 312), becomes a participant 210, and is added as a member of each of the predetermined groups.

The system then obtains preferential information describing the participant's 210 preferences (step 314) for one or more decision objects. The preferences of the participant 210 are then used to evolve decision objects (step 316) within the decision object population. Additionally, decision objects may be evolved based on preferential information obtained from all other participants. Once the participant 210 has completed his survey, his session ends (step 318) and he may exit the survey.

In some embodiments, the exclusion process does not end the candidate's 202 participation. Instead, since the candidate 202 is already engaged in the survey process, preferential information may still be obtained from him (path 320). In some versions, the candidate's 202 preferences about decision objects may be obtained, but are not used to evolve the decision object population. Instead, these preferences may be used to perform non-real-time (i.e., post-fielding) preference analysis such a conjoint analysis, or simply discarded. Additional information from a questionnaire or other non-convergent exercise may also be obtained despite exclusion.

FIG. 3B depicts an excluding step in accordance with one embodiment of the invention illustrated in FIG. 3A. In FIG. 3B, the excluding step (step 306 in FIG. 3A) begins by choosing a group n (step 322) that the candidate 202 will be a member of if the candidate were to become a participant 210. The excluding step (step 306) then determines if adding the candidate would cause that group to exceed a specified representation threshold (step 324). Differing versions of this embodiment provide alternate means for calculating this threshold. In some versions, the specified threshold is based on the desired percentage representation for the group in question (RTn), multiplied by the total number of survey completions up to that point, (total completes or TC). The excluding step could be expressed as follows:
Pn>TC*RTn
wherein Pn is the desired number of completes for group n (including candidate 202.) If the expression above tests true, then candidate 202 would be excluded from participating.

In other versions, tolerance bands are defined around the threshold. These can take two forms: a percentage-based tolerance band or an absolute upper/lower bound deviation from the target group size. In the former case, a percentage tolerance is allowed around the target representation percentage for the group under consideration, e.g., a target percentage of 25% of all candidates ±5%, or, stated another way, 20-30%. of all candidates. The combined test may be expressed as:
Pn>(TC*RTn)+max[(TC*RTn*PTUBn), ATUBn]
wherein the tolerance deviation is the greater of the total completes multiplied by the desired representation percentage multiplied by the percentage tolerance upper bound for group n (PTUBn) and the absolute tolerance upper bound for group n (ATUBn). This deviation may be an absolute allowable deviation irrespective of candidate population size, or it may be a relative deviation based on a percentage of all candidates 202. One skilled in the art will recognize that other deviation functions will need to be applied to meet sampling criteria of each specific survey and thus such functions are covered within the spirit of the invention.

Based on the determination made in step 324, if the candidate's 202 admission to the survey would exceed the specified threshold, then the candidate (or his input) is excluded from the survey (step 326). If allowing the candidate 202 into the survey would not exceed the specified threshold, he is not excluded at this point (step 328) and the excluding step 306 proceeds to check the respective thresholds for each remaining group (step 330) the candidate 202 is a potential member of. If allowing the candidate 202 does not exceed any of those thresholds, the candidate is allowed to take part in the survey.

FIG. 3C depicts another excluding step (step 306 in FIG. 3A), found in another embodiment of the invention illustrated in FIG. 3A. In this embodiment, the steps preceding the excluding step are the same as those described above in reference to steps 302 and 304 in FIG. 3A. As in step 322 of FIG. 3B, in this embodiment, the invention begins by choosing a group that the candidate (step 332) will be a member of if allowed into the survey as a participant 210. However, instead of checking to see if adding the candidate 202 to this group exceeds this group's specified threshold as is described in FIG. 3B, the system determines whether adding the candidate to this group would cause the population of any other group to fall below a specified representation threshold (step 334). Again, differing versions of this embodiment provide alternate means for calculating this threshold. In some versions the specified threshold is a percentage of all candidates who have been allowed to participate in the survey. In other versions, the specified threshold is a percentage range between a minimum and a maximum allowable percentage of all candidates, e.g., 25% of all candidates ±5%, or, stated another way, 20-30%, as well as an absolute group threshold. This may be expressed as:
Pn<(TC*RTn)−max[(TC*RTn*PTLBn), ATLBn]
wherein the tolerance deviation is greater of the total completes multiplied by the desired representation percentage multiplied by the percentage tolerance lower bound for group n (PTLBn) and the absolute tolerance lower bound for group n (ATLBn). Again, the absolute tolerance bound for the group is an integer number that does not depend on the respondent population size. This deviation may be an absolute deviation irrespective of candidate population size, or it could be a relative deviation based on a percentage of all candidates. One skilled in the art will recognize that other deviation functions will be necessary to apply to meet sampling criteria of each specific survey and thus such functions are covered within the spirit of the invention.

Based on the determination made in step 334, if the candidate's admission to the survey would cause any group to fall below its threshold, then the candidate is excluded from the survey (step 336). If allowing the candidate 202 into the survey would not cause any group to fall below its threshold, he is not excluded at this point (step 338) and the excluding step 306 proceeds to check the respective thresholds for each remaining group (step 340) the candidate is a potential member of. If allowing the candidate 220 does not exceed any of those thresholds, the candidate is allowed to take part in the survey becoming a participant 210.

To illustrate the excluding step 306 of FIG. 3C, assume fifty candidates are have participated in a survey to-date, 26 are male, 24 are female, with the specified threshold being 50% representation for each gender ±2%. As the 51^{st} candidate 202, a male, attempts to enter the survey, the groups he would not be a part of are evaluated. If adding the male to the candidate population would cause the female portion to be underrepresented, then he cannot be added. In this scenario, adding the male would cause the female representation to drop from 48%, which is within acceptable tolerances, to 47%, which is not. The male is therefor rejected, as other male candidates 202 will be, until another female candidate 202 is admitted into the survey.

Beneficially, the excluding steps (step 306) described in FIGS. 3B and 3C may be combined, in any order, to control candidate 202 selection. For example, in one embodiment, every group the candidate 202 will be a member of is checked for over-representation, and finding no reason to exclude him, then every group he is not a member of is checked for under-representation. In other embodiments, the check for under-representation of non-member groups occurs first.

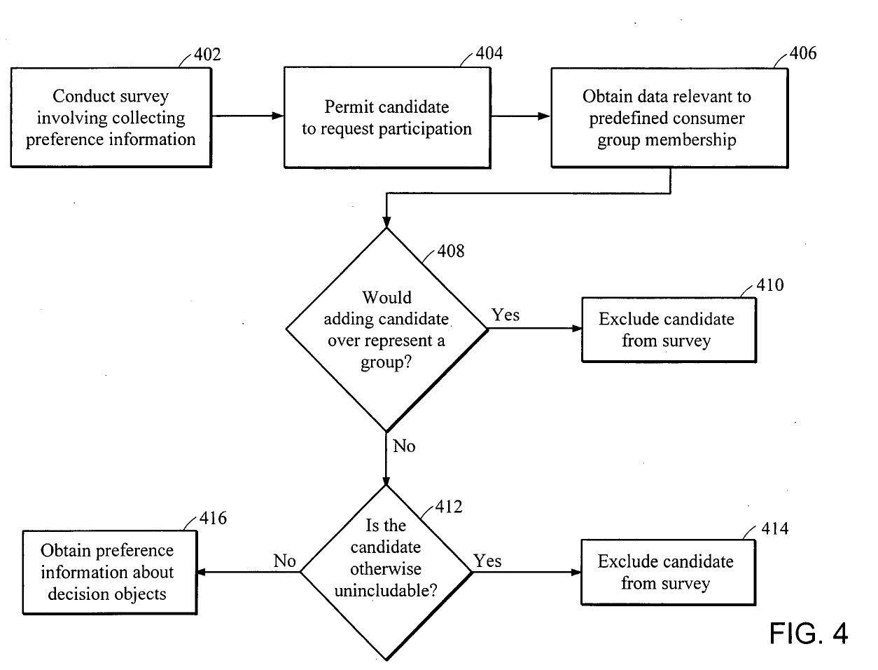

FIG. 4 illustrates another aspect of the invention, a method for assessing the preferences of an objectively predefined consumer group from among decision objects. In this aspect, decision objects comprise various forms of a product, or different product options. The process begins by conducting a survey involving displaying various decision objects to consumers and collecting preference information (step 402).

The process then permits a candidate 202 to request participation (step 404). Data is obtained relevant to determining whether the candidate may be classified as a member of a predefined group (step 406). Groups may be based on information similar to the candidate information described previously. Next, a determination is made to assess whether or not adding the candidate 202 would over-represent a group (step 408). If adding the candidate 202 would over-represent a group, then he is excluded from the survey (step 410). Using the example above, if the survey had 26 males and 24 females, the act of adding another male, given the requirement of 50% representation ±2%, would cause the male subtype to be over-represented by 1% and thus he could not be included.

If adding the male candidate 202 is allowed, a determination is made if the candidate is otherwise objectively unincludable (step 412). Continuing the example, if the survey had a requirement that all candidates 202 had to be between the ages of 25 and 34, and a 24-year old female candidate attempted to join the survey, though she fits within the gender subtype requirements, she is objectively not includable due to her age. If the candidate 202 is objectively unincludeable, the candidate is therefore excluded (step 414). Note that in various embodiments, determining objective includability may occur either before or after any other excluding step.

If both rejection criteria, non-over-representation (determined in step 408) and includability (determined in step 412), are overcome, the candidate 202 is allowed to become a participant 210 and participate in the survey, and her input is used in the survey. Preference information is obtained from the participant (step 416) and other participants 210.

From the foregoing, it will be appreciated that the systems and methods provided by the invention afford an effective way to select candidates for survey participation.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method of evaluating a candidate for participation in a survey, comprising:
(a) obtaining, over an electronic network, information describing the candidate;
(b) categorizing the candidate as a potential member of one or more predetermined groups, based upon the information obtained in step (a);
(c) for each of the one or more predetermined groups, if adding the candidate to that group would increase the population in that group beyond a specified threshold, excluding the candidate from participating in the survey, and otherwise adding the candidate as a member of each of the one or more predetermined groups and allowing the candidate to participate in the survey; and
(d) if the candidate is allowed to participate in the survey, obtaining from the candidate preferential information describing the candidate's affinity for one or more decision objects.

2. The method of claim 1, further comprising evolving one or more decision objects based upon the preferential information obtained in step (d).

3. The method of claim 2, further comprising identifying one or more preferred decision objects based upon additional preferential information obtained from at least one other member of the one or more predetermined groups.

4. The method of claim 1, wherein the obtained information includes one or more of the candidate's:
age;
race or ethnicity;
marital status;
predisposition to purchase a particular product;
income range;
gender;
occupation;
socio-economic classification;
level of education;
physical characteristics;
health;
geographic location; and
whether or not the candidate has previously participated in a survey.

5. The method of claim 1, further comprising, if the candidate is excluded from participating in the survey, nevertheless obtaining the candidate's expressed preferences for one or more decision objects.

6. The method of claim 1, further comprising, if the candidate is excluded from participating in the survey, obtaining additional information from the candidate.

7. The method of claim 1, wherein the specified threshold comprises a percentage of all candidates who have been allowed to participate in the survey.

8. The method of claim 1, wherein the specified threshold comprises a percentage range between a minimum and a maximum allowable percentage of all candidates.

9. The method of claim 8, wherein the specified threshold further comprises either a relative deviation based on a percentage of all candidates or an absolute allowable deviation.

10. A method of evaluating a candidate for participation in a survey, comprising:
(a) obtaining, over an electronic network, information describing the candidate;
(b) categorizing the candidate as a potential member of one or more predetermined groups, based upon the information obtained in step (a);
(c) for each of the one or more predetermined groups, if allowing the candidate to participate in the survey would decrease the population of any group below a specified threshold, excluding the candidate from participating in the survey, and otherwise adding the candidate as a member of each of the one or more predetermined groups and allowing the candidate to participate in the survey; and
(d) if the candidate is allowed to participate in the survey, obtaining from the candidate preferential information describing the candidate's affinity for one or more decision objects.

11. The method of claim 10, further comprising evolving one or more decision objects based upon the preferential information obtained in step (d).

12. The method of claim 11, further comprising identifying one or more preferred decision objects based upon additional preferential information obtained from at least one other member of the first one or more predetermined groups.

13. The method of claim 10, wherein the obtained information includes one or more of the candidate's:
age;
race or ethnicity;
marital status;
predisposition to purchase a particular product;
income range;
gender;
occupation;
socio-economic classification;
level of education;
physical characteristics;
health;
geographic location; and
whether or not the candidate has previously participated in a survey.

14. The method of claim 10, further comprising, if the candidate is excluded from the survey, nevertheless obtaining and recording the candidate's expressed preferences for one or more decision objects.

15. The method of claim 10, further comprising, if the candidate is excluded from the survey, obtaining additional information from the candidate.

16. The method of claim 10, wherein the specified threshold comprises a percentage of all candidates who have been allowed to participate in the survey.

17. The method of claim 10, wherein the specified threshold comprises a percentage range between a minimum and a maximum allowable percentage of all candidates.

18. The method of claim 17, wherein the specified threshold further comprises either a relative deviation based on a percentage of all candidates or an absolute allowable deviation.

19. A computer system connected to an electronic network, the system configured to perform the following steps:
(a) obtaining information describing a candidate over the electronic network;
(b) categorizing the candidate as a potential member of one or more predetermined groups, based upon the information obtained in step (a);
(c) for each of the one or more predetermined groups, if allowing the candidate to participate in the survey would decrease the population of any group below a specified threshold, excluding the candidate from participating in the survey, and otherwise adding the candidate as a member of each of the one or more predetermined groups and allowing the candidate to participate in the survey; and
(d) if the candidate is allowed to participate in the survey, obtaining from the candidate preferential information describing the candidate's affinity for one or more decision objects.

20. The system of claim 19, further comprising the step of evolving one or more decision objects based upon the preferential information obtained in step (d).

21. The system of claim 20, further comprising the step of identifying one or more preferred decision objects based upon additional preferential information obtained from at least one other member of the one or more predetermined groups.

22. The system of claim 19, wherein the obtained information includes one or more of the candidate's:
age;
race or ethnicity;
marital status;
predisposition to purchase a particular product;
income range;
gender;
occupation;
socio-economic classification;
level of education;
physical characteristics;
health;
geographic location; and
whether or not the candidate has previously participated in a survey.

23. The system of claim 19, wherein if the candidate is excluded from participating in the survey, nevertheless obtaining the candidate's expressed preferences for one or more decision objects.

24. The system of claim 19, wherein if the candidate is excluded from participating in the survey, obtaining additional information from the candidate.

25. The system of claim 19, wherein the specified threshold comprises a percentage of all candidates who have been allowed to participate in the survey.

26. The system of claim 19, wherein the specified threshold comprises a percentage range between a minimum and a maximum allowable percentage of all candidates.

27. The system of claim 26, wherein the specified threshold further comprises either a relative deviation based on a percentage of all candidates or an absolute allowable deviation.

28. A method for assessing, over an electronic network, the preferences of an objectively predefined consumer group from among decision objects comprising various forms of a product, the method comprising:
(a) while conducting a survey involving collecting, over a network, preference information regarding various decision objects displayed to consumers over the network, permitting a potential new candidate to request participation in the survey;
(b) obtaining, through the network, data relevant to determining whether the candidate may be classified as a member of an objectively predefined consumer group;
(c) excluding the candidate from participating in the survey if either adding the candidate would result in over representation of a subtype of consumer in the group, or the candidate objectively is not includable in the group; and
(d) otherwise, allowing the candidate to participate in the survey and obtaining preference information from the candidate indicative of the candidate's affinity for one or more decision objects.

29. The method of claim 28, further comprising evolving one or more decision objects based upon the preference information obtained in step (d).

30. The method of claim 29, further comprising identifying one or more preferred decision objects based upon additional preference information obtained from at least one other member of the consumer groups.

31. The method of claim 28, wherein the data includes one or more of the candidate's:
age;
race or ethnicity;
marital status;
predisposition to purchase a particular product;
income range;
gender;
occupation;
socio-economic classification;
level of education;
physical characteristics;
health;
geographic location; and
whether or not the candidate has previously participated in a survey.

32. The method of claim 28, further comprising, if the candidate is excluded from participating in the survey, nevertheless obtaining the candidate's expressed preferences for one or more decision objects.

33. The method of claim 28, further comprising, if the candidate is excluded from participating in the survey, obtaining additional information from the candidate.

34. The method of claim 28, wherein the over representation of a subtype of consumer in the group comprises causing the percentage of the subtype to exceed a maximum allowable percentage of all candidates who have been allowed to participate in the survey.

35. The method of claim 28, wherein the over representation of a subtype of consumer in the group comprises causing the percentage of the subtype to exceed a maximum allowable percentage of all candidates or causing the percentage of another subtype to fall below a minimum allowable percentage of all candidates.

36. The method of claim 35, wherein the maximum allowable percentage further comprises either a relative deviation based on a percentage of all candidates or an absolute allowable deviation.

37. The method of claim 35, wherein the minimum allowable percentage further comprises either a relative deviation based on a percentage of all candidates or an absolute allowable deviation.
